(19) United States
(12) Patent Application Publication
(10) Pub. No.: US 2023/0222929 A1
(43) Pub. Date: Jul. 13, 2023

(54) Syncretic Learning Management System

(71) Applicants: Maria S. LaBarge, Logan, UT (US); Sarah Anne Ruiz, Logan, UT (US)

(72) Inventors: Maria S. LaBarge, Logan, UT (US); Sarah Anne Ruiz, Logan, UT (US)

(73) Assignee: FuturEd, LLC, Logan, UT (US)

(21) Appl. No.: 17/885,266

(22) Filed: Aug. 10, 2022

Related U.S. Application Data
(60) Provisional application No. 63/232,477, filed on Aug. 12, 2021.

(51) Int. Cl. G09B 5/02

(52) U.S. Cl. CPC G09B 5/02

(57) ABSTRACT

Current learning management systems employ a teacher narrative approach on a points out of points possible approach in online and blended learning environments. The Syncretic Learning Management System supports four distinct learning methodologies, which are generally applied solitarily, and does so in a manner that enables a fully supported personalized, competency based, interdisciplinary, learner disposition, student narrative choice learning process. Through its circular design, as apparent in the learner homepage and navigation views, the SLMS effectively and efficiently maximizes learning, choice in progression, and mastery achievement in less time by facilitating guidance and assessment of multiple methods or pathways. The personalized, user experience is optimized by the syncretic functions of self-selected choice in learning activities for mastery and learning dispositions that align with the learner’s optimal progression while combining standards in a thematic approach.

### CROSS REFERENCE TO RELATED APPLICATIONS

Application Number to previously submitted Provisional Application: 63232477

### STATEMENT REGARDING FEDERAL SPONSORSHIP

This invention was not created with funds or sponsorship from the United States Federal Government.

### BACKGROUND OF THE INVENTION

### Technical Field

A learning management system (LMS) is a software application for the administration, documentation, tracking, reporting, automation, and delivery of educational courses, training programs, or learning and development programs. Learning management systems were designed to identify training and learning gaps, utilizing analytical data and reporting. In their use for K-12 and higher education classrooms, an LMS can support learning in an online or blended learning delivery that can support a range of uses, acting as a platform for online content, asynchronous or synchronous based, and a format to connect the student with the teacher or professor via communications or work submission.

An LMS can be either hosted locally or by a vendor. A vendor-hosted cloud system tends to follow a SaaS (software as a service) model. All data in a vendor-hosted system is housed by the supplier and accessed by users through the internet, on a computer or mobile device. Vendor-hosted systems are typically easier to use and require less technical expertise. An LMS that is locally hosted sees all data pertaining to the LMS hosted internally on the users internal servers. Locally hosted LMS software will often be open-source, meaning users will acquire (either through payment or free of charge) the LMS software and its code. With this, the user is able to modify and maintain the software through an internal account.

Through an LMS, teachers may create and integrate course materials, articulate learning goals, align content and assessments, track studying progress, and create customized tests for students. An LMS can display content in modules or units, with content and assignments or tasks, and quizzes to be completed by the student within a designated timeline. In such, a benefit of an LMS is that students can have around the clock access to learning content and teacher feedback. Through course design or outside adapter integrations, learners with unique situations, who are often marginalized, can have accessible content and alternative submission options. Such systems have built-in customizable settings for varied assessments and gradebook management and tracking. Thus, learners can see virtually, on a device, their graded work and comments, course progress, and communicate with instructors who can monitor the effectiveness of learning. In the United States, popular LMSs include Blackboard, Canvas, and D2L or Brightspace, and Moodle. With the increasing popularity of home schooling and global public health crises such as the COVID pandemic, effective LMS’s are both needed and gaining momentum.

Despite the increasing popularity of LMS’s, there remains significant gaps in options and capabilities. For example, current LMS’s fail to optimize student choice, interdisciplinary learning, research-backed learning styles and methods, and versatility. Additionally, learner progress and grading, whether on a points or mastery system, is fundamentally based on a points out of points possible division outcome leading to a percentage or numeric score. Therefore, learning markers are subject to a numeric system and the teacher narrative of what should be displayed or obtained to show mastery instead of focusing on a student narrative of their background knowledge, existing mastery of skills and content, and decisions on how to achieve competency at all levels.

### WORKS CITED

Bloom, Benjamin Samuel. Taxonomy of Educational Objectives. Longman, 1979.

Gardner, H. (1993). Multiple Intelligences: The Theory in Practice. New York: Basic Books, 2011.

Silver, et. al, “Integrating Learning Styles and Multiple Intelligences.” ASCD. Vol. 55, No. 1. Sep. 1, 1997. https://www.ascd.org/el/articles/integrating-learning-styles-and-multiple-intelligences . Last accessed: Aug. 04, 2022

### SUMMARY

In accordance with the above, a new syncretic LMS (SLMS) is provided that optimizes student choice, interdisciplinary learning, research-backed learning styles and methods, and versatility through a student choice learning management system comprising a plurality of learning modules to facilitate student achievement of common core standards, with learning modules divided into interdisciplinary subjects and levels of difficulty, and means by which a student can select an individually customized pathway through the learning modules based on subject matter.

### DESCRIPTION OF DRAWINGS

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is an exemplary user interface in one embodiment of the SLMS.

FIG. 1A is a first flow chart showing the pathway of the user from the available options on the home page options in one embodiment of the SLMS.

FIG. 1B is a second flow chart showing the database repositories connected to the choices a user can select on the home page options in one embodiment of the SLMS.

FIG. 2 is a first diagram showing exemplary interdisciplinary aspects in one embodiment of the SLMS.

FIG. 2A is a third flow chart showing exemplary repositories of interdisciplinary materials.

FIG. 3 is a second diagram showing exemplary levels of learning in one embodiment of the SLMS.

FIG. 3A is a fourth flow chart showing how a teacher user designates a level of learning type from an interdisciplinary repository and places it in a learning circle.

FIG. 3B is a fifth flow chart showing how a student user moves through levels of mastery within a learning circle.

FIG. 4 is a third diagram showing exemplary varied content according to Gardner’s Theory of Multiple Intelligences embodiment of the SLMS.

FIG. 4A is a sixth flow chart showing how a teacher user designates a learner disposition tags into a leveled task in a learning circle.

FIG. 4B is a seventh flow chart showing how a student user moves through interdisciplinary content with leveled mastery tasks and appending learner dispositions within a learning circle.

FIG. 5 is a fourth diagram showing exemplary levels of learning with enhanced learning supports and/or customization in one embodiment of the SLMS.

FIG. 5A is an eighth flow chart showing how a teacher user designates intervention supports or advanced materials to a task in a learning circle.

FIG. 5B is a ninth flow chart showing how a student user navigates through mastery learning levels and accesses intervention or advanced materials.

FIG. 6 is a fifth diagram showing exemplary levels of learning and pathways within them in one embodiment of the SLMS.

FIG. 7 is a sixth diagram showing exemplary feedback in one embodiment of the SLMS.

### DETAILED DESCRIPTION

The present invention in its various embodiments, some of which are depicted in the figures herein, is a syncretic learning management system (SLMS) comprised of four learning methodologies. SLMS is organized, in large part, around learning circles, each such circle of which corresponds to a learning unit or module with a combination of interdisciplinary subjects organized around Common Core standards and allowing for degrees of student subject matter selection and level advancement. More specifically, within SLMS, students may select which subject area in which they wish to work. Learning circles are further subdivided into levels of difficulty and/or proficiency such that, as a student obtains mastery at one level of learning circle, she or he is automatically presented with a same-subject learning circle of greater difficulty, and so on. In preferred embodiments, SLMS includes around twelve (12) units per term, although any number of units may be included without departing from the purposes or scope of the invention; units can be added or deleted as needed for each term.

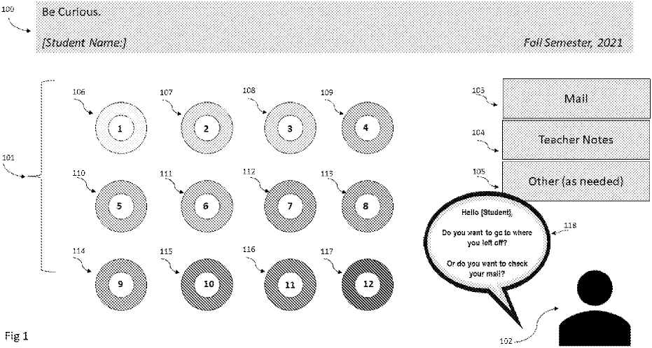

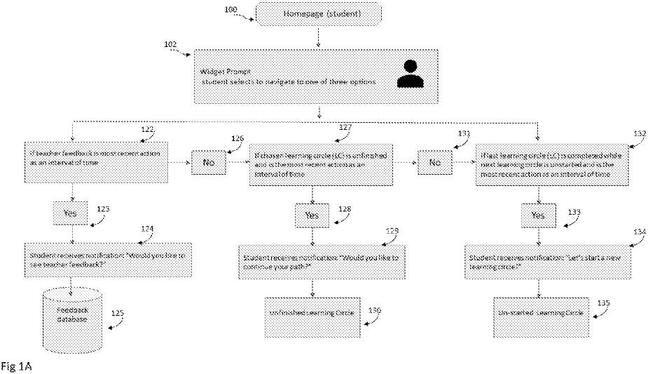

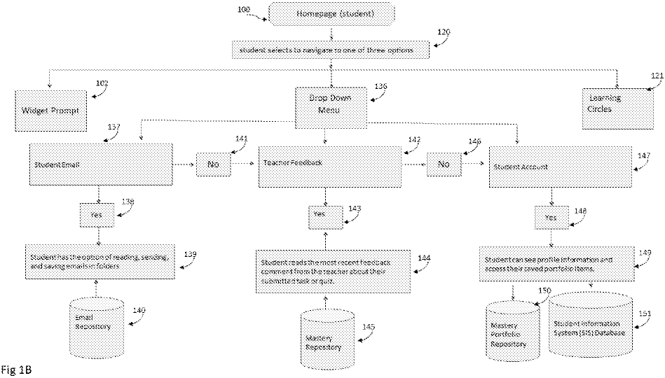

FIG. 1 is an exemplary user interface 100 or home/landing page in one embodiment of the SLMS is shown. A plurality of circles 101 is presented (comprised of 107 – 118) which signifies the number of units in a term, with each circle linking to the learning materials contained within said units. Students begin with the first circle and then subsequently enter into learning material in that subject area. Upon completion, students return to the homepage to move in succession through the remaining circles (coursework units). SLMS and/or user interface 100 may include any number of other ancillary features such as: a student avatar/widget 102 to prompt students with options for beginning study sessions, such as checking mail from classmates 103, teacher feedback 104, student account 105, and starting where the student left off in a previous session 106.

FIG. 1A is a flow chart student pathway within the home/landing page wherein the widget or avatar 102 prompts the learner based on a numerality of prompts based on the most recent action as an interval of time. For example, 122-125 shows the flow of reviewing teacher feedback, 126-130 continuing an unfinished learning circle, and 131-135 starting a new circle. The function to choose an unfinished learning circle 130 is calculated as follows; Lcincomplete= Σ(Lc0 colored... + Lcn colored...+Lcn+1 colored) - Σ(Lc0gray... + Lcn gray... + Lcn+1 gray) and the function to choose an unstarted learning circle is Lcunstarted=Σ(Lc0colored+Lcn+1colored) - (Lcn+1gray-Lcngray).

FIG. 1B depicts the continued options within the home/landing page wherein the drop down menu 136 has three commands, student email 137, teacher feedback 142, and student account 147. Thus, when a user selects the email pathway, 137-140, communications are made available from the email repository database. Or, if the teacher feedback option is no, choose pathway 141-144, then the student is shown the latest response comment provided by the instructor on their task or quiz, which information is being drawn from the mastery database. Additionally, when the student account pathway is activated, 146-151, then student information can be viewed, updated, and portfolio tasks are able to be accessed. If the student chooses to continue working where the student left off, the widget prompt takes the student directly to the last learning circle the student is currently working in.

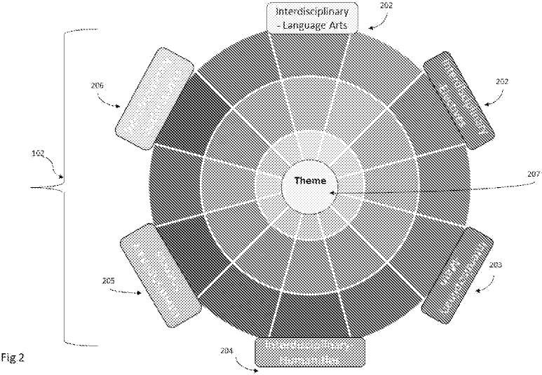

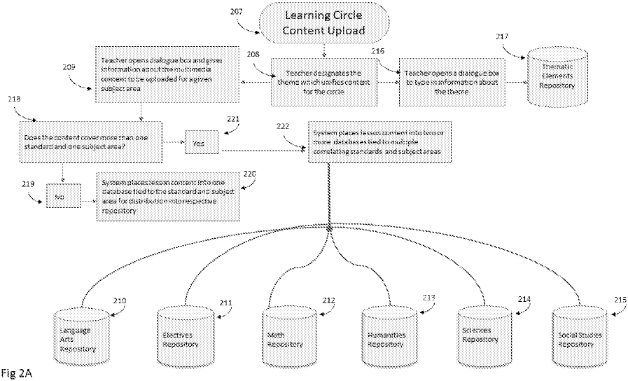

FIG. 2 is a second diagram comprising the learning materials within the unit selected on the homepage with exemplary interdisciplinary aspects in one embodiment of the SLMS is shown within a learning circle hub 200. Learning circles within SLMS are organized by learning unit around a theme 207, and further subdivided into multiple interdisciplinary subject areas, such as, for example, language arts 201, electives 202, math 203, humanities 204, sciences 205, and social studies 206. Themes may be drawn from any discipline in the core curriculum including the humanities, for example, as the humanities creates ties to all other disciplines through creativity, expression, and representation. In the illustrated embodiment, the center 207 of the learning circle represents the portal to introductory materials that introduce the theme and content of the unit. The SLMS enables the diverse subject areas to be woven together into a fully integrated interdisciplinary curriculum. Further, in the SLMS, skills are preferably mastered by students according to requirements set by Common Core Standards developed and taught within integrated themes 207 and interdisciplinary subjects (e.g., 201, 202, 203, 204, 205, 206) which are customizable.

FIG. 2A Content materials can be arranged in a fully integrated interdisciplinary curriculum based on these content themes or subjects 209-215, 217. Teachers can customize and import multi-media materials to any portion of the learning circle hub. As shown in pathway 209, 210-215, 218, 221, 222, an integrated environment, content may be combined and integrated between core and elective disciplines. For example, social studies combine with math problems. Math problems combine with science or language arts. Humanities can be combined with science and so forth. Students can fluidly navigate between disciplines learning about the given subject matter, while practicing and developing core skills. Students enter the specific content through its interface location designated by the learning circle 208 and FIG. 2 items 201-207, wherein each gradient color reflects content uploaded by teacher 210-215. This user-friendly system enables teachers to upload course materials from the content library, adapting subjects and themes to students’ needs.

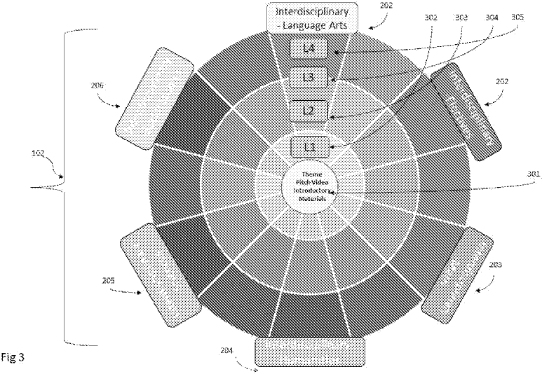

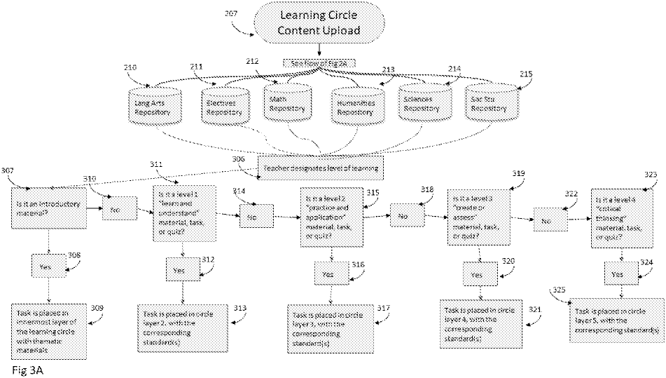

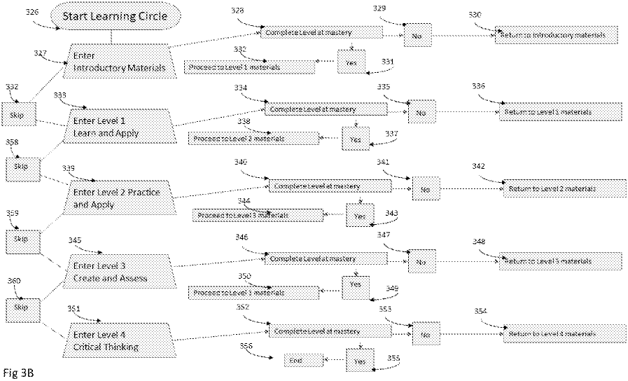

In operation FIG. 3, the SLMS hosts low to advanced learning materials and is designed to sponsor content layers such as those that follow Bloom’s Taxonomy with the addition of Critical Thinking Skills. In Bloom’s Taxonomy, students’ progress from understanding and remembering skills to application and analysis skills. Students then progress to skills in evaluation and creativity. FIG. 3 is one embodiment of the SLMS indicating the student navigation access of the exemplary levels of learning as designated The SLMS supports and displays teacher uploaded content that flows from low to high levels of difficulty, e.g., L1 (302), L2 (303), L3 (304), and L4 (305) displayed as radiating outward from the inner circle 301 to the utmost parts. In one exemplary embodiment of the learning level aspects of the SLMS: L1 (302) may host learning activities and materials that develop skills and content mastery in terms of understanding and remembering; L2 (303) may contain learning activities develop skills and content mastery in terms of application and analysis; L3 (304) may have learning activities for developing skills and content mastery in terms of evaluation and creation and L4 (305) may allow for the uploading of activities that develop skills and content mastery in terms of critical thinking skills such as compare and contrast, making judgements, evaluating sources, understanding judgment criteria, and other mental and evaluative processes. Students navigate the learning circle and progress into the content layers 302, 303, 304, 305 after completing the materials in the center 301 of the learning circle hub.

FIG. 3A denotes continuation of teacher designations with regard to level content materials 306. Within this structure and system, teachers designate materials according to learning levels and corresponding standards 306-325. From the discipline repositories 210-215, teachers designate the learning level of the materials within the repository based on a gradient scale from introductory to levels 1-4 which are representative of lower to higher degrees of difficulty 309, 313, 317, 321, 325. Once the content material is linked to the appropriate standard(s) and mastery level, the item is linked within the learning circle 101.

FIG. 3B indicates how the SLMS is designed to allow students to move from low to high learning. The SLMS signals students when they have reached proficiency in any level. Mastery of each level is dependent upon a variety of scenarios which can be summarized from either completing the necessary tasks in a given sublevel or achieving proficiency at the next highest level or mastering the highest level available. The Function of mastery can be equal to the highest level achieved for all subjects and sublevels skipped or mastery of a sublevel that is designated as minimum proficiency for that subject or mastery of each sublevel and subject in the circle or a combination of skipping levels, achieving mastery at a higher level in one subject, while following a particular subject from low to high levels in a linear fashion. If a student follows a linear path, they begin at introductory materials 327, then complete level 1 at mastery 334, 337, 338 after which they progress to level 2, once at mastery 340, they move up and so forth. Likewise, options 357, 358, 359, 360 are the skip function where a student can move to the next mastery level and attempt to master at a higher level and pass off two lower levels. Once a student receives mastery at level 4, the learning circle is complete 351, 352, 355, 356.

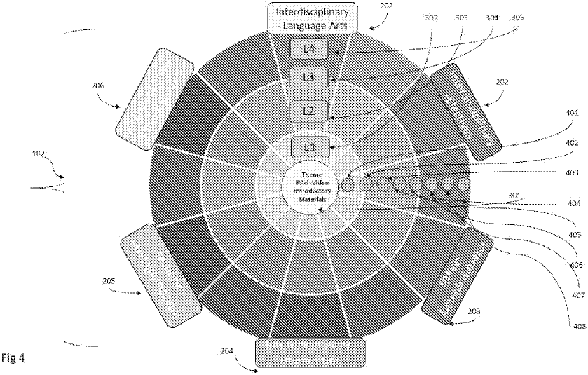

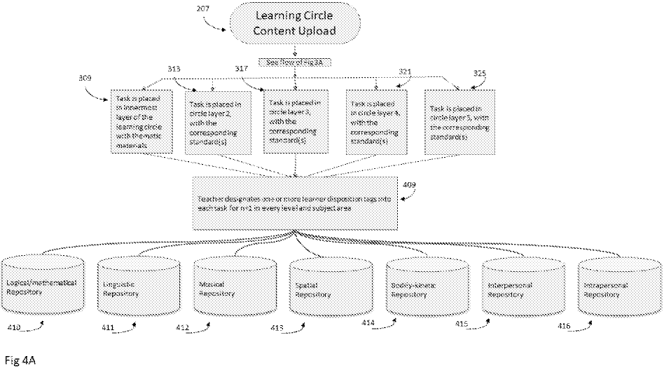

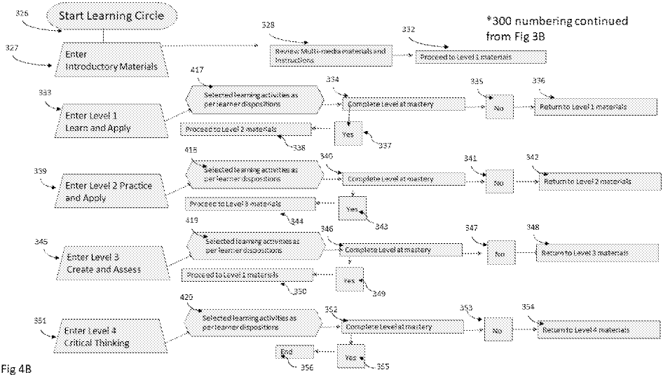

FIG. 4 is a fourth diagram of exemplary levels of learning, interdisciplinary content, and learner dispositions in one embodiment of the SLMS as shown. When teachers are designing activities to fit within a learning circle, they may account for complexity and learner modalities or styles. Gardner’s Theory of Multiple Intelligences finds that students tend to gravitate to particular learning preferences, such as: logical/mathematical 401, linguistic 402, musical 403, spatial 404, bodily-kinetic 405, naturalist 406, interpersonal 407, or intrapersonal 408. Teachers can upload materials and learning experiences in each intelligence, as well as upload links to outside materials and multimedia sources that support student preferences and challenge students to work outside their preferred styles as well. These learning preferences will be tagged in each activity within a learning circle so students can choose something that is a strength or weakness. In requiring a learner tag to be added to activities, teachers will be able to identify if all learning styles are evident in their teacher narrative. Students will also be able to recognize their own learner narratives.

FIG. 4A is continuation of FIGS. 2A and 3A displaying how a teacher uploads content materials, tasks, and/or quizzes, after the standard and correct layer placement within a subject and mastery level; a subsequent addition of learner dispositions are completed. The teacher is able to link a material, task, and/or quiz to the type of learning styles 410-416.

FIG. 4B is a continuation of diagram FIG. 3B indicating the process of navigation wherein students proceed through interdisciplinary content along mastery levels 326-356 as per student choice of learning activities according to multiple learner dispositions 410-416. Learning activities according to each learner disposition (401 -408) are contained within each mastery level. As with the level of difficulty, students can move forward to next level materials or repeat levels and advance through multiple diverse disposition activities until mastery is achieved 326-356, 401-408, 417-420. In addition to the levels of complexity from the inner circle to the outer circle, each level contains learner modalities. Students have learning propensities of their approach to obtaining and synthesizing information, often referred to as learner styles or multiple intelligences. In order to add an activity to a learning circle, it needs to have three criteria identified and tagged: the interdisciplinary subjects covered FIG. 2A 220, 222, 210-215, the level of complexity FIG. 3A 306-325, and what learner modality approach is used FIG. 4A 409-416.

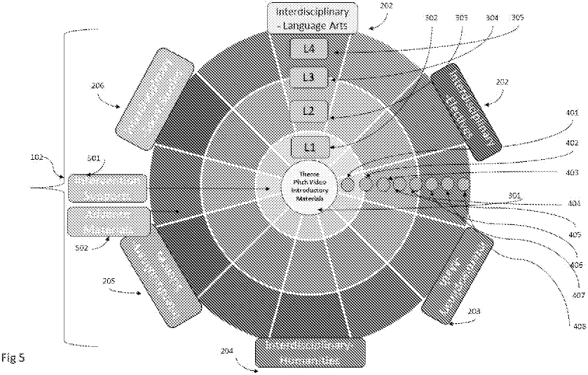

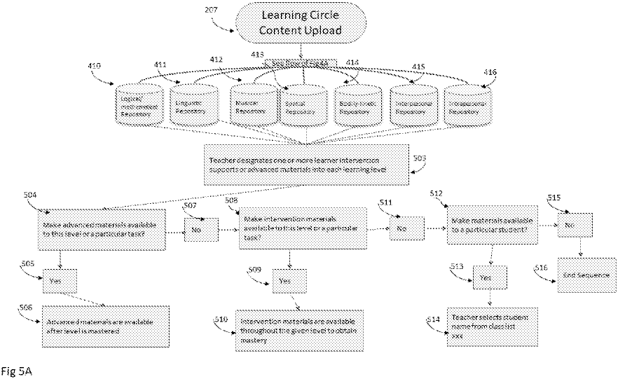

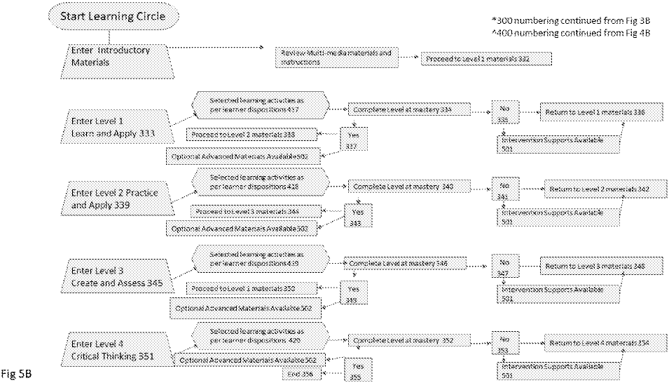

FIG. 5 is a fifth diagram with exemplary levels of learning and enhanced learning supports and/or customization in one embodiment of the SLMS as shown. To address diversity and the influence of socio-economics on learning styles and competency levels, the SLMS includes modules and features for real-time intervention filters 501, 502, to support students in their chosen path rather than after mastery is not obtained. For example, students can have access to a picture dictionary or translating help if English is their second language. If their individualized plan requires a shortened workload, teachers can use a toggle switch that automatically reduces workload or options available to students in their path. Likewise, writing supports can be a constant to be able to organize their thoughts into a written paragraph when writing goals are present. Therefore, students who need extra support can have access to supportive technology 501 throughout their learning circle. In the upper limits of the circle, the most complex activities and content to master 502 is available to all students. Students who tend to move through learning units quicker, can spend more time in the upper layer to achieve mastery for the advanced student. The upper layers will have advanced critical thinking materials presented to them for a more challenged and deeply learned approach if they quickly show mastery of the lower levels. Therefore, complex content is available sooner in their learning path rather than as an extension if they have completed a set list of assignments previously. With intervention supports for struggling learners within the system, students who are not always privy to advanced activities can have the opportunity to be successful in higher levels.

As with FIGS. 2A, 3A, 4A, FIG. 5A demonstrates how teachers upload and link intervention supports and advanced materials making these available to learners 503-516. Teachers can turn on or off levels depending on the needs of each individual student 512-516. For example, the teacher can disable low level materials in order to encourage an advanced student to focus on the advanced learning experiences.

FIG. 5B visages student access to intervention supports 501 and advanced materials 502. Advanced materials 502 become available within all learning levels 333, 339, 345, 356 and as early as level 1. In the event students need additional support, intervention materials are available within the process of returning to current level materials 335, 341, 347, 353 for obtaining mastery. Teachers can turn on or off levels depending on the needs of each individual student. For example, the teacher can disable low level materials in order to encourage an advanced student to focus on the advanced learning experiences.

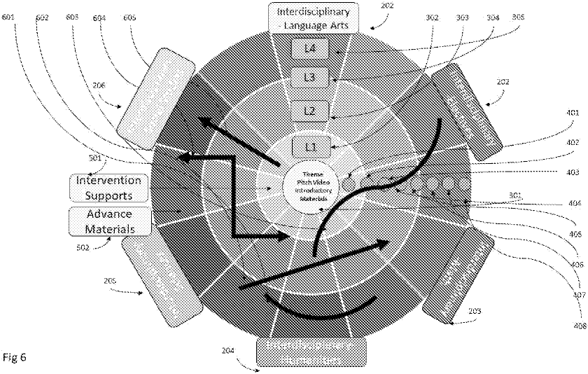

FIG. 6 is a sixth diagram showing exemplary levels of learning and pathways within them in one embodiment of the SLMS is shown. The SLMS revolves primarily on student choice. Instead of a designated learning path made by a teacher, the student can select learning experiences and pathways (e.g., 601, 602, 603, 604, 605) according to their comprehension of the materials and learning needs. It is highly individualized and self-directed. Students can determine when and how they show mastery of skills. Some students choose to finish all learning activities in one hybrid-interdisciplinary subject such as language arts 601, while others might skip around 605, 603, 605 or finish all learning activities on one learning level 604. It is student directed that enables students to learn at their pace and move through, above or below levels, as needed.

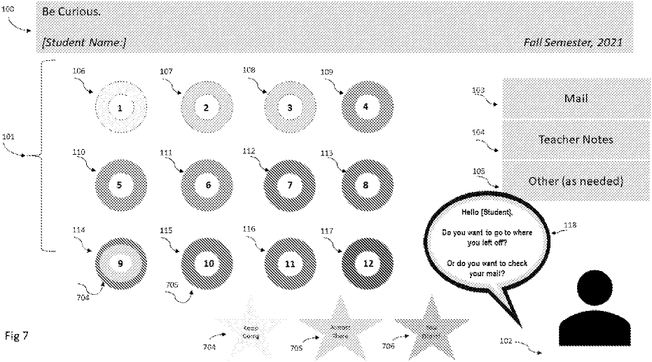

FIG. 7 is an exemplary user interface 100 or home/landing page in one embodiment of the SLMS as shown. As noted, a plurality of circles 101 is presented (comprising 107 - 118) which signifies the number of units in a term, with each circle linking to the learning materials contained within said units. FIG. 7 is a seventh diagram showing exemplary feedback in one embodiment of the landing page of the SLMS as shown. The SLMS may incorporate various indicators 701, 702, 703, to show students their progress, from initial engagement to proficiency and accomplishment. Progress indicators appear on the homepage and encourage students throughout their use of the SLMS. The learning circle is envisioned as complete when the student has obtained mastery, no matter how many activities the student has completed. The SLMS tracks student progress and notifies them when proficiency or mastery is accomplished. When a learning circle has been completed, according to any number of predetermined criteria, a corresponding indicator on the homepage indicates that the area has been completed. FIG. 7 also displays the flow of the learning circle based on its visual coloration, whether it is a fully colored, partially colored, or non-colored/gray learning circle 118, 704, 705, 706 that are displayed on the student view embodiment of the SLMS in a home/landing page. The suggested pathway to complete mastery in a learning circle is determined by the level of coloration it may have. A completely colored-in circle, pathway 107-114, displays mastery of the curriculum and skills within the circle. A partially colored circle displays student progress towards mastery fulfillment in the learning circle 704. Lastly, an uncolored or gray learning circle 705, 706, 707, indicates a learning circle has not been started.

We claim:

1. A learning management system comprising:.

2. An online, software-based platform designed to integrate the four once stand alone learning methodologies of interdisciplinary, competency based, learner modalities, and student choice into one synchronous learning methodology of circular based components of several disciplinary subjects in which the student user is in command of its path of learning based on the learning activities made available by the teacher/mentor user within the cohesively managed constraints of the four learning methodologies working in tandem for each level and subject matter of learning pertinent to the required common core standards for the age level.

3. The system of claim 1 wherein the learning management system’s learner circles are a fully integrated interdisciplinary curriculum that ties learning subjects together thematically.

4. The system of claim 2 wherein the learning management system recognizes six distinctive sections of disciplines (Language Arts, Mathematics, Science, Social Studies, Humanities, and Electives) as separate parameters that can have the same standards and count for mastery in multiple fields within one learner circle.

5. The system of claim 3 where the visual display of a learner circle is a circle with 6 triangular slices inside the outside circumference parameter lines, having a different color to signify the distinct subject matter fields tied together based on the thematic tie and introductory materials.

6. A method of content knowledge and skills mastery of standards within individual disciplines or interdisciplinary combination of similar standards, the learning management system supports standard based and competency based learning where the student’s abilities or knowledge is assessed, given opportunities to practice, assessment again, and determination of mastery or to approach the content or skill again.

7. The system of claim 5 that designates the method of student navigation of content from low to high levels of complexity, as the lowest level of mastery is in the first rung, the middle level of mastery is in the second rung, the middle-high level of mastery is in the third rung, and the high or advanced level of mastery is on the last rung.

8. The system of claim 5 where the visual display of the mastery levels appears as four tiered rings within the individual subject matter sections and concentric circles within the interdisciplinary model, beginning from the introductory materials and radiating out to the end boundaries of the learning circle.

9. A method of utilizing learner dispositions, along with the system of claim 7 of a competency trajectory of knowledge and skills attainment, to identify learning activities within the scope of the eight multiple intelligences of a learner.

10. The system of claim 8 where the visual display of learner dispositions where each modality has a specific icon displayed on the activity or task.

11. The system of claim 9 wherein the display of each learning activity or task is tied to a level of complexity (as described in claims 5-7) and when accessed by the learner, it displays the instructions, information pertaining to its completion, and notification of mastery progress and achievement.

12. A method of navigation of materials and obtainment of mastery is drive by student choice and the pursuance of a personal narrative of learning instead of a teacher-driven schematic narrative design, in which mastery can be obtained throughout the complexity levels and through the interdisciplinary concepts as a personalized path instead of mastery solely based on points out of points possible function of calculation.

13. The system of 11 operates with multiple pathways available to achieve mastery based on the learner’s prior knowledge, skill, and learning dispositions. The system recognizes alternate paths of student choice as options like “complete highest level of mastery”.

14. The system of 12 occurs with the additional option of “skip a lower level and complete the next highest level at mastery”.

15. The system of 13 occurs with the additional option of “move through a low to medium to high progression of content and skill in one discipline to achieve mastery”.

16. The system of 14 occurs with the additional option of a unique combination of several paths that could include the above options and additional learning presets based on the system of 5.

17. A method of real time support for learners with need interventions or advanced materials in which additional content is provided for learners who cannot obtain mastery at any given level of complexity. Instead of supportive lessons or tutoring being presented at the end of a learning unit or path, the intervention is present and always available. Additionally, advanced materials are readily present for learners which complete mastery of the outermost layer of critical thinking at a faster pace in comparison to an average time to complete mastery.

18. The system of 16 wherein the invention materials are linked to each mastery level or subject level task or item for immediate help and access.

19. The system of 17 wherein the advanced materials are accessible beyond the outermost layer of critical thinking if the mastery path is completed.

20. A display of the initial login home page of the learner with the interdisciplinary circles for the designated learning time (i.e. a term or semester) with a chosen avatar for navigation tips, an inbox for communicating with the mentor or teacher, and mastery progression notifications. The learner navigates to a learning circle to begin the process of learning described in systems 4, 7, 10, and 16; until all learning circles have obtained mastery for the parameters of time.
